(19) United States
(12) Patent Application Publication
(10) Pub. No.: US 2011/0067375 A1
(43) Pub. Date: Mar. 24, 2011

(54) RAKE FOR GROOMING SURFACES

(76) Inventor: Antonio Madaffer, Naples, FL (US)

(21) Appl. No.: 12/563,080

(22) Filed: Sep. 18, 2009

(51) Int. Cl. A01D 7/00

(52) U.S. Cl. 56/400.16; 56/400.21

(57) ABSTRACT

A rake comprising a rake body and a tine assembly that is removably mounted to the rake body. The tine assembly is modular in design so that it can readily be interchanged with other tine assemblies and/or replacement tine assemblies. Additionally, the rake is constructed so that the tines may be advanced by simple manual effort without tools in order to replenish tine length lost to wear during use.

### TECHNICAL FIELD

The present invention relates generally to rakes, and more particularly to rakes that are used to groom surfaces, such as clay tennis courts; non-grassy areas of baseball and softball fields, especially the base path and pitcher's mounds; bocce courts; sand traps, waste bunkers and cart paths on golf courses; and the like.

### BACKGROUND OF BACKGROUND

Sports surfaces composed of clay, sand, or other loose granular materials require grooming to ensure a substantially smooth and consistent surface, whether flat or contoured, on which to play the sport. Traditional grooming tools include conventional rakes and brooms, handheld or tractor pulled booms which trail a heavy fabric, metal or polymer blade, or metal mesh, and the like. While these tools often perform adequately, the experience of the person performing the grooming as well as the condition or state of the materials comprising the surface itself as well as the condition of the tool being used may result in inconsistent treatment and an uneven playing surface. Such is particularly of concern in tennis, baseball and softball where the players rely upon and expect a true bounce and not an errant or erratic bounce owing to unevenness in the sport surface.

It is a principal object and advantage of the present invention to provide an improved grooming rake that is adapted to be either manually pulled or pulled by a vehicle, such as a work mule, golf cart, tractor, or the like.

It is another object and advantage of the present invention to provide a grooming rake that avoids or mitigates against bouncing as the rake is moved over uneven surfaces and/or objects in the surface being groomed, e.g., lines of a tennis court, particularly when being towed by a powered vehicle.

It is another object and advantage of the present invention to provide a grooming rake that provides a surface grading capability to smooth out elevated surfaces and fill recesses in the surfaces.

It is another object and advantage of the present invention to provide a grooming rake whose tine lengths are easily and readily adjusted so as to useful with respect to a plurality of different surfaces and surface types.

It is another object and advantage of the present invention to provide a grooming rake whose tine lengths are easily and readily adjusted as the tine elements wear down so as to maintain a generally uniform tine tension or force against and/or a generally consistent tine depth in the surface being groomed.

Finally, it is a further object and advantage of the present invention to provide a tine assembly that is modular in construction so as to be easily and readily removed from the rake body for replacement and/or repair or to exchange the existing tine assembly for another of a different configuration to accommodate a change in the surface type to be groomed.

### SUMMARY OF THE INVENTION

In accordance with the foregoing objects and advantages, there is provided a grooming rake which, in one embodiment, generally comprises an elongated rake body having an interior and an exterior surface and a tine assembly connected to one of said interior or exterior surfaces. The tine assembly generally comprises first and second elongated rails positioned in parallel spaced relation to one another, each rail having a plurality of spaced, substantially equidistant, opposing holes and/or recesses, and a plurality of spaced, parallel tines extending from the first rail to and through the second rail to a point some distance from the second rail. The tine elements are fixed relative to the first rail but are capable of reciprocating through the hole or recess in the second rail. When the tine assembly is mounted to the rake body, the tine will extend below the bottom edge of the rake body a predetermined distance. In its preferred embodiment, the tine assembly is a modular unit that is removable as a single element from the rake body.

According to a second embodiment there is provided a grooming rake as described above further comprising a plurality of securing means securing the tine assembly to the rake body and a plurality of adjusting means for adjusting the distance the tines extend from the rake body. In a preferred mode of this embodiment, the first rail is capable of movement relative to the second rail without removing the tine assembly from the rake body. Most preferably, the tine length can be adjusted manually, without the use of tools and without fully disengaging any fastener elements.

According to a third embodiment there is provide a grooming rake assembly comprising a rake body having associated therewith a tine assembly and either a handle or a tow bar extending from the rake body wherein the longitudinal axis of the rake body, and hence the tine assembly, is angled relative to the longitudinal axis of the handle or tow bar such that when the rake body is being pulled, the longitudinal axis of the tine assembly is other than 90° to the pull path. The handle or tow bar may be fixed to the rake body or it may be capable of adjustment so that the user can adjust the angle relative to the need. In a preferred embodiment, the angle of the handle or tow bar relative to the longitudinal axis of the rake body is from about 10° to about 45°, most preferably from about 15° to about 35°.

According to a fourth embodiment there is provided a grooming rake wherein the handle or tow bar pivots relative to the rake body, the pivoting motion defining a plane that is perpendicular to the longitudinal axis of the rake body or, if the rake body is angled relative to the handle or tow bar, likewise angled relative to the longitudinal axis of the rake body. In use, the pivoting motion is limited and is generally no more than 30°, preferably no more than 20°. The pivoting means may have associated therewith a dampening means, such as a spring or rubber compression element.

Finally, according to a fifth embodiment there is provided a tine assembly generally comprising first and second elongated rails positioned in parallel spaced relation to one another, each rail having a plurality of spaced, substantially equidistant, opposing holes and/or recesses, and a plurality of tines extending through the holes or recesses in the rails in spaced, parallel relation to one another, wherein each tine is fixed relative to the first rail and is capable of reciprocating through the hole or recess in the second rail and further extends at least partially outwardly from said second rail. In a preferred embodiment, the first rail and the second rail are temporarily fixed relative to one another so that the second rail will not inadvertently dislodge itself from the tines unless and until intended. Most preferably, the rails are fixed in a space relationship, the spacing being consistent with the spacing when the tine assembly is installed in the rake body.

### BRIEF DESCRIPTION OF THE DRAWINGS

The present invention will be more fully understood and appreciated by reading the following Detailed Description, in which:

FIG. 1 is a perspective view of a grooming rake according to the present application;

FIG. 2 is a perspective view of a rake body with the tine assembly in place;

FIG. 3 is a partial perspective view of the rake body of FIG. 2;

FIG. 4 is a cross-sectional view of the rake body of FIG. 2 taken along line 3-3.

FIG. 5 is a partial perspective view of the rake body of FIG. 2 with a portion of the rake body removed, exposing a portion of the underlying tine assembly;

FIG. 6 is a cross-sectional view of the tine assembly taken along line 6-6 of FIG. 5;

FIG. 7 is a cross-sectional view of a tine assembly;

FIG. 8a is a plan view of one embodiment of a link element;

FIG. 8b is a plan view of a second embodiment of a link element;

FIG. 9a is a plan view of a “U” shaped tine;

FIG. 9b is a plan view of a nail head tine;

FIGS. 9c and 9d are alternate views of a flattened head tine;

FIG. 10 is a perspective view of an alternate embodiment of a grooming rake pulled by a motorized vehicle; and

FIG. 11 is a perspective view of a cut-away portion of an alternate embodiment of a grooming rake.

FIGS. 12a and 12b are partial perspective views of alternate embodiments of a tine advance mechanism.

### DETAILED DESCRIPTION

The grooming rake according to the present application comprises three key components: a tine assembly, a rake body, and a rake handle or tow bar. Although, as will become apparent in the discussion below, certain features to be described in this application have applicability to a rake wherein the tine assembly or at least a portion thereof is integral to and forms a part of the rake body, the present application is most especially directed to a unitary or modular tine assembly wherein the tine assembly may be readily mounted to and removed from the rake body as a single component. It is this latter configuration that is the focus of the discussion below.

In its most general construct, the tine assembly comprises first and second elongated rails positioned in parallel spaced relation to one another, each rail having a plurality of spaced, substantially equidistant, holes and/or recesses with the holes or recesses of one rail being opposed to the holes or recesses on the other rail. The tine assembly further comprises a plurality of tines extending through the holes or recesses in the rails in spaced, parallel relation to one another, wherein each tine is fixed relative to the first rail and is capable of reciprocating through the hole or recess in the second rail and further extends at least partially outwardly from said second rail and, when the tine assembly is mated with the rake body, from the rake body itself.

The tines may be individual linear elements having a head at one end or they may be “U” shaped elements formed by bending a longer, linear tine element in half In the former case, the head prevents the tine element from fully passing through the hole or recess in the first rail. In the latter case, the bend or medial point of the U shaped tine element serves to stop the advancement of the individual legs of the tine through the first rail element. Here each leg of the U tine forms an individual tine so far as operation of the rake is concerned. Although various materials may be used to make the tines, preferably the tines are of stainless steel wire as stainless steel has excellent tensile and flex strength as demanded by the intended applications, is resistant to weather and oxidation, and has good wear resistance and durability. The specific grade and diameter of the stainless steel will depend upon the specific end use application; however, it has been found that 316 hardened stainless steel wire of from 8 to 12, preferably 10-11, gauge, is especially suitable for fine granular surfaces like clay and clay based surfaces such as tennis courts.

Similarly, the number of tines and the separation between tines will depend upon the intended use and how it is to be used. Generally speaking, the tine, spacing will be at least one quarter inch and no more than one inch, most preferably, the tine spacing it about one-half inch. The overall length of the tine assembly, as defined by the length of the rail elements, may be a matter of inches or feet. For example, the tine assembly of a handheld rake may be no more than 10 inches in length whereas the tine assembly of a rake to be pulled by a powered vehicle may be four or more feet in length.

The rails themselves may be formed or molded or they may be cut from an extrusion. The rails may be made of plastic, a plastic based composite, or metal, especially aluminum. The rails may be hollow or solid and preferably have at lest two planar or substantially planar surfaces, one to mate with the mounting surface of the rake body, as described below, and the other having the holes or recesses for securing the tines. Preferably, the rails are solid and of an “L” shaped cross-section and, most preferably are made of aluminum.

As noted above, the tines are fixed to the first rail. Fixture may be achieved by any number of means. For example, the tines may be spot welded, fusion bonded, adhesive bonded or potted in place. Preferably, though, especially so that the tine assembly is capable of repair and reuse, the tines are held in place by physical means, most especially by a guard rail that effectively locks the tine heads or the medial portion of the U shaped tines in place. The guard rail is generally of equal or substantially equal length to the first rail and will have at least one planar surface which overlays the tine heads and/or medial portion of the U shaped tine elements. The guard rail is fixed relative to the first rail so as to firmly secure the tines in place.

In addition to the foregoing elements, the tine assembly will have a plurality of fastener elements, typically threaded assembly elements and/or compressive/interference type quick release elements by which the tine assembly is attached to the rake body and, if present, by which the guard element may be secure to the first rail. These fastener elements may be made of metals or plastic, preferably metal given the strength needs, and most preferably stainless steel or another rust or oxidation resistant material. Suitable fastener elements are well known and include, but are not limited to, nuts and bolts, wing nuts and bolts, knob bolts and nuts, etc. As will be discussed below, certain of these elements may also play a role in the advance and metered advance capabilities of the tine assembly.

Of particular benefit to the grooming rakes of the present application is the fact that the tine assembly can be readily removed and replaced. This allows one to purchase and store replacement tine assemblies for immediate use should the existing tine assembly be damaged and worn out. Because the second rail element moves freely relative to the tine elements, it can readily slide off of the tine elements if not handled properly. To avoid this happenstance, especially while in storage or during handling, a tie, rope, band, elastic band, or other like strapping element or a clip may be use to secure the second rail element to the first rail assembly. Alternatively, holes may be drilled in opposing surfaces of the first and second rails for receiving a bolt that temporarily holds the two rails in fixed relationship and which is removed upon mounting the tine assembly to the rake body. In these instances, the second rail element is slid up the tine elements until it meets and sits adjacent to the first rail assembly and then secured in place using the strapping element, fastener, or other suitable securing means.

Although strapping, fastening, or clipping the rails to one another eliminates concern with respect to the second rail sliding off the tines, it exposes nearly the full length of the tines to potential damage, particularly bending, which can adversely affect the operation of the rake both in terms of its ultimate performance as well as its tine advancing capabilities. Thus, it is preferred to use at least two temporary linking elements which link the first rail to the second rail in a spaced relationship, preferably the same spacing as is used when mounting the tine assembly to the rake body. In its most simple embodiment, the linking element may be a flat strip of a rigid material, preferably a metal or plastic, having two holes at opposite ends whereby the holes align with the fastening elements of the first and second rails in the assembled state of the tine assembly. When the tine assembly is to be mounted to the rake body the linking element is simply removed and discarded. Alternatively, the linking element may be a flat strip having a hole at one end and a slot running from the other end to a point intermediate the length of the link element. In this embodiment, the slot will generally be of similar dimensions as the slot of the advance mechanism of the rake body, as discussed in more detail below. In this case the linking element need not be discarded since the slot coincides with the slot on the rake body and the advancing mechanism is still operational with the linking element in place. Indeed, with this latter configuration, any possibility of the second rail becoming dislodged from the tines during handling and installation is eliminated.

The second key element of the grooming rake is the rake body. Depending upon the intended use of the rake and how it is to be used, the rake body may be flat (much like a traditional lawn rake) or, for most applications, especially applications other than hand held rakes, the rake preferably has a contoured body that has a bevel or fold about its longitudinal axis: “longitudinal axis” of the rake body being defined as that axis parallel to the axis of the rails. For convenience, the following discussion of the rake body will be made with respect to the beveled body; though it will be appreciated that the discussion is equally applicable to the flat body as if the beveled body were merely flattened out. The beveled rake body has an upper surface and a lower surface. The angle between the planes of the upper surface and the lower surface varies depending upon the nature of the rake and how it is to be used. For example, a hand held rake will have a very shallow angle, if any. For example, the angle may be from about 5° to about 30°, preferably from about 10° to about 20°. On the other hand, a rake that is to be towed will tend to have a much larger bevel angle, generally from about 50° to 90°, preferably from about 60° to 80°. Ultimately the goal is to have an inner angle of the tines to the surface to be groomed of from 50° to 90°, preferably from about 60° to 80°. Too low of an angle and the rake tines have a greater tendency to rise, thereby allowing accumulated clay, sand, etc. to pass under the tines. Too high of an angle and the tines have a greater tendency to catch, causing the rake to bounce rather than to run smoothly along the grooming surface, or to build up a large amount of granular material in front of the tine elements increasing the likelihood that the tines will ride up on the accumulate granular material and leave a mound thereof on the groomed surface.

The upper surface of the rake body has attached thereto or integrated therewith a handle or tow bar for pulling the rake. The lower or, more appropriately termed, the mounting surface is that surface to which the tine assembly is mounted such that the planes of the mounting surface and the tine assembly are parallel to one another. While the tine assembly can be mounted to the exterior surface of the mounting surface, it is preferable that it be mounted to the interior surface, or the underside, of the mounting surface of the rake body.

The mounting surface has a plurality of holes along its lower edge, i.e. that edge opposite the fold, for receiving the fastener elements associated with the second rail. Although one may use hand releasable fastener elements for securing the second rail to the rake body, it is preferred to use tool tightened and loosened fasteners. Additionally, intermediate the lower edge of the mounting surface and the bevel, the mounting surface will have a plurality of equally positioned, relative to the lower edge, rows of substantially equally spaced holes, the rows being perpendicular to the longitudinal axis of the rake body. Accordingly, an imaginary line drawn through each of the first hole in each row, through each of the second hole in each row, etc., will be parallel to the longitudinal axis of the rake body. The spacing between the holes in each row and the number of holes in each row will vary depending upon the end use application of the rake and the overall length of the tines employed. However, it is generally thought that a spacing of one-quarter to one inch, preferably about one-half inch, is appropriate and that the number of holes in each row, expressed as the length of the row, is generally from a couple inches to six inches or more, preferably from about two to four inches.

According to one embodiment, the holes in these rows are for receiving the fastener elements associated with the first rail, with each successive being associated with the tine advancing capability of the tine assembly. Specifically, as the tines wear down through use, the fastener for the first rail is unsecured and removed and the first rail advanced so that the through holes in the first rail align with the next hole in the row. The fastener for the first rail is then inserted into the next hole and tightened to once again secure the first rail to the rake body. In essence, progression of the fastening element from one hole to the next, with the concurrent advance of the first rail, results in the advancement of the tines through the second rail and outward from the lower edge of the rake body. The extent of the tine advance is consistent with the distance between the holes.

Generally, the number of rows of holes to be employed will depend upon the length of the longitudinal axis of the tine assembly. If the length of the tine assembly is less than two feet or so, then only two rows are needed, each being placed an inch to a few inches in from the ends of the rake body, along the longitudinal axis. If the tine assembly is more than two feet or so, then it is preferred to place at least one additional row of holes intermediate the other two. Where the tine assembly is extremely large, it is best to employ a plurality of rows of holes with each spaced about sixteen to twenty-four inches from each other: again keeping a row near each end of the tine assembly. This construction is desired in order to provide a more firm and secure rake.

Alternatively, fastening of the first rail and operation of the tine advance mechanism may simply involve the use of a plurality of slots in place of the rows of holes discussed above. Here a fastener, preferably a hand releasable fastener, extends through the slot and a corresponding hole in the first rail and secures the first rail to the rake body when tightened. When one wants to advance the tines, one simply loosens the fastener elements and advances the fastener element along the slot. Unlike the previous embodiment, the fastener elements are not fully disengaged. Thus, the loosened fastener can simply slide in the slot, carrying with it the first rail to which it is still attached. Depending upon the size of the tine assembly, it is to be appreciated that one may have to assist the movement of the first rail. Nevertheless, the advancement is achieved without disengaging the fastener or the first rail.

While the foregoing certainly simplifies the operation of the rake, because the rakes are subject to shaking, vibration and jolting in use, one may have concern that the hand tightened fastener securing the first rail in place will loosen, thereby allowing the rail to move, most likely retract, thereby retracting the tines as well. To avoid this happenstance, it is desirable to modify the slots so as to provide a plurality of extensions of the slot perpendicular to or angled with respect to the longitudinal axis of the slots, essentially providing a saw tooth contour to the slot side with the slot extensions being the gaps between the teeth. When one wants to advance the tines, one simply loosens the fastener and advances the fastener to the entry point for the next gap. At this point, one then moves the fastener transversely so that the fastener stem slides into the gap. If the gap is angled, then one moves the fastener transversely with some retraction in the forward motion. When the stem of the fastener reaches the end of the gap, one simply tightens the fastener. In order to accommodate the transverse movement of the first rail fastener, the first rail will have plurality of slots, instead of holes, along its longitudinal axis, whose length is consistent with the maximum transverse movement of the first rail fastener in the modified slots. In the assembled state of the rake, the slots in the first rail align with but are perpendicular to the longitudinal axis of the modified slots in the mounting surface. In its preferred embodiment, the smooth sided slots will be employed together with a row of holes, as described above. The slots will generally be of equal length and parallel to the rows of holes. While each slot may be positioned several inches from its associated row of holes, each slot is preferably no more than one to two inches from its associated row of holes. In this embodiment, the fastener elements for securing the first rail to the mounting surface extend through the slots and not the holes in the mounting surface. In this embodiment, the first rail will have a hole, to be aligned with the slot, for accepting the first rail fastener element. Associated with this hole will be a stop element protruding outward from the upper surface of the first rail towards the surface of the mounting surface of the rake body. The orientation and alignment of the stop element is such that when the tine assembly is securely mounted to the mounting surface, the stop elements engage and penetrate into a hole in each of the row of holes.

When one desires to advance the tines, one simply loosens the fastener element sufficiently to allow the first rail to back away form the mounting surface, thereby causing the stop element to clear the hole. In this respect, it is to be noted that the stem of the fastener is quite long so as to ensure that the fastener can be sufficiently loosened to effect the tine advance without disengaging the stem from its counterpart fastening element on the underside of the tine assembly.

Once the stop element clears the hole, the first rail may then be advanced to align the stop element with the next hole in the row of holes. The fastener element is then retightened and the stop element now penetrates the new hole. This use of the row of holes and the stop element ensures consistent advancement of the tines and, more importantly, prevents or at least greatly reduces the possibility that the tine assembly, most notably the first rail and, hence, the tines themselves, will move during use, especially if the fastener loosens during use. As noted, the fastener must back off a considerable amount before the stop element will clear the hole.

While the stop element may be a nub, bolt, cylindrical element, and the like fixed to the upper surface of the first rail, preferably the rake is configured and designed so that the fastener element which secures the guard rail to the first rail, as discussed above, is aligned with the row of holes and that portion of which extends from the surface of the first rail is sufficiently long so as to penetrate the hole when the tine assembly is mounted to the mounting surface. For example, the guard rail fastener may be a nut and bolt assembly in which either the nut or the head, depending upon which is to serve as the stop, is domed or of another high profile construction. The height must be sufficient so that when the first rail is secured to the mounting surface that element of the fastener aligned with the hole must protrude into the hole, preferably most if not all the way into or even through the corresponding hole in the mounting surface. Additionally, it is important that the diameter of the fastener element serving as the stop have a diameter that is less than, preferably slightly less than, the diameter of the holes in the rows. One wants to ensure that the stop element is able to readily penetrate and retract from the hole without any interference or the need for additional force. To achieve this dual function, when securing the guard rail to the first rail, the guard fastener must be oriented perpendicular to the tines, with that portion to serve as the stop extending outward from that surface of the first rail to face the mounting surface when assembled.

A further optional feature of the rake body, and one that is especially desirable for large rakes and those rakes that are to be towed by a motorized vehicle, is the presence of an additional flange along the top edge of the upper surface of the rake body. The presence of this flange provides torsional stability and added strength to the rake body, and is particularly important where the rake body is made from a thin sheet of metal, such as aluminum. Preferably, the flange is angled 90° or nearly so relative to the plane of the upper surface and extends along the full or at least the middle third, if not the middle half, of the top edge of the upper surface. The width of the flange, i.e., the distance the flange extends outward from the top edge of the upper surface, will generally be from about one-half to two inches, most preferably about one inch. Wider flanges can be used but are not necessary. Thinner flanges could be used, especially if the rake body already has good physical strength, however, in the case of weak or thin upper surface panels, thinner flanges are not likely to provide sufficient rigidity and torsional stability.

The rake body may be made from a number of materials including metals and plastics and by a number of methods such as stamping, compression molding, injection molding, thermoforming, and the like. For example the rake body may be formed from a single sheet of sheet metal including stainless steel, aluminum, steel, and the like. Alternatively, the rake body may be thermoformed from a thermoplastic sheet or fiber or mat reinforced thermoplastic or thermosettable sheet. The rake body may also be molded from thermoplastics or thermosettable materials and resins. While all such materials may be suitable, some may be more suitable than others for a particular rake and its application. For example, in the case of a handheld rake or a rake to be pulled by a vehicle for sand traps, it may be preferable to use lightweight materials; whereas, it may be more desirable to use a heavier material for a large rake to be pulled by a tractor on, for example, a baseball diamond where it may be necessary to rake out deep ruts formed during a ball game.

The third key element of the grooming rake is the handle or tow bar. Like the rake body, the shape, size, and make-up of the handle or tow bar is a matter of preference and how the rake is to be used. In the case of a hand held rake, the handle is preferably made of wood or a plastic material or composite. If the rake is to be towed by a vehicle, the tow bar is preferably made of metal or a plastic or composite material. Again, the types of materials and the method of making a handle or tow bar from them are well known.

The handle or tow bar is affixed to the upper surface of the rake body, preferably at or near the midpoint of the upper surface along the longitudinal axis. The handle or tow bar may be affixed to the exterior or interior surface of the upper surface of the rake body; but is preferably affixed to the exterior surface, especially if the handle or tow bar is to have the ability to be angled relative to the longitudinal axis of the rake body. Those skilled in the art will readily appreciate different means by which the handle may be affixed to the upper surface of the rake body. For example, in the case of a molded rake body, the attachment site may have a handle or tow bar seat molded into the upper surface that securely receives one end of the handle or tow bar and/or provides additional reinforcement to the attachment site while also providing holes for fasteners to securely fasten the end of the handle or tow bar to the seat. Alternatively, and preferably, the attachment site on the upper surface of the rake body will have a plurality of through holes which holes align with through holes on the handle or tow bar for accepting fasteners for securely fastening the latter to the former. Traditional mechanical fastening means, such as nuts and bolts, may then be used to securely affix the handle or tow bar to the rake body. Where there is concern for the strength and integrity of the attachment site on the upper surface of the rake body and the ability of the rake body to withstand the forces to be exerted on the through holes, it may be desirable and preferred to employ a reinforcing plate having through holes consistent with the through holes in the rake body, through which the fastening elements pass. The reinforcing plate may be a metal or plastic plate and is placed on the upper surface of the rake body opposite the handle or tow bar is placed: thereby sandwiching the upper surface between the reinforcing plate and the handle or tow bar or whatever assembly, if any, is used to secure the handle or tow bar to the rake body.

The handle or the tow bar may be affixed to the rake body in an orientation that is perpendicular to the longitudinal axis of the rake body or it may be angled with respect to the same. Angling of the handle or tow bar causes the tine assembly, and hence the row of tines, to be at an angle relative to the forward motion of the grooming rake. The angled handle or tow bar adds a grading capability to the rake. As the rake is pulled forward, there can be a tendency for excess soil, clay, sand, etc., to build up in front of the tines. Like a snow plow or grade plow on a road grader, with the continued forward movement of the rake, the excess material moves along the plane of the tines eventually exiting the rake body at the trailing end of the tine assembly. This avoids or at least lessens the possibility that too much material will build up in front of the tines (the front being the face of the tines facing the forward movement of the grooming rake) causing the rake to ride up on the excess material and leave behind a mound or ridge of material on the groomed surface.

To accommodate the angled handle or tow bar, the holes in the attachment site of the upper surface of the rake body are bored in an alignment that provides the desired angle. Alternatively, and preferably, there may be a plurality of holes in the upper surface: a pivot hole and a plurality of option holes, the option holes being equidistant from the pivot hole, one of which is oriented such that when the handle or tow bar is attached using that hole, the handle or tow bar is perpendicular to the longitudinal axis of the rake body. The other option hole or holes are placed so as to provide a predetermined angle to the handle or tow bar. Generally speaking, if the handle or tow bar is to be angled relative to the rake body, the angle, defined as the number of degrees the handle or tow bar is off the perpendicular, will be from 10° to 45°, preferably from 15° to 35°.

Alternatively, there may be a pivoting handle or tow bar mount at the attachment site on the upper surface which pivoting mount is capable of rotating about a pivot point where the mount is fixed to the upper surface. The mount may comprise two opposing circular discs having a plurality of radial oriented, interlocking grooves and ridges whereby when the two elements are axially, along the axis of the pivot point, moved away from one another the interlocking elements of the two opposing faces disengage. One of the circular discs is fixedly attached to an outer surface of the handle or tow bar at or near the end to be attached to the rake body and the other circular disc is fixedly attached to the upper surface of the rake body at the handle or tow bar attachment site. Alternatively, the circular disc will be affixed to the underside of the hinge body or other body, if any, as discussed below. A pivot fastener, preferably a nut and bolt, passes though a bore in the handle (or the hinge body base, if applicable), a central bore in each of the circular discs and a bore in the upper surface of the rake body and serves as the pivot axis for the mount. The angle of the handle or tow bar to the longitudinal axis of the rake body may be altered by loosening the pivot fastener so that the handle or tow bar can be lifted from the upper surface sufficient to allow the interlocking elements of the mount members to disengage. The handle or tow bar is then pivoted about the pivot axis to the desired angle and the pivot fastener tightened: thereby securing the handle or tow bar to the rake body and causing the interlocking elements of the circular discs of the mount to re-engage so as to lock the angle.

In yet another preferred embodiment the handle or tow bar is indirectly attached to the upper surface of the rake body by a hinge element affixed to the upper surface of the rake body at the handle/tow bar attachment site. The hinge maybe a free hinge, i.e., no counter forces, or it may have a spring or other compressive element, e.g., a rubber disc, built in so as to help absorb any shock or movement of the handle or tow bar relative to the rake body when the tines hit an object or a rigid surface or other element in the surface to be groomed. The hinge element allows relative motion of the handle or tow bar in a plane perpendicular to the plane of the upper surface. The extent of movement allowed by the hinge is small, generally 20° or less, preferably 10° or less, from one extreme to the other. The addition of the hinge element surprisingly provides a dampening effect, reducing or eliminating any bouncing caused by the tines hitting an object or other element beneath or in the surface being groomed, e.g., lines of a tennis court. Otherwise, such bouncing may adversely affect the performance of the grooming rake, most notably the smoothness of the groomed surface.

As noted above, the nature of the tow bar attachment can affect the tendency of the rake to bounce. Another means of dampening or mitigating rake bounce is by adding weight to the rake body. Because much of the rake can be constructed of relatively thin sheet metal, plastics and the like, the overall weight of the rake may be insufficient to prevent bounce, especially on certain surfaces, particularly compact fine granular surfaces. Consequently, it may be desirable to add weight to the rake body. This can be accomplished in a number of ways. For example, one may mount a superstructure on the upper surface of the rake body which superstructure is configured to hold weights or rocks. The superstructure could be a coral-type structure having four walls defining a receptacle. Alternatively, the superstructure may be one or more cylindrical elements, e.g., piping, mounted on the rake body which is designed to accept weights having a central bore whose diameter is greater than the diameter of the pipe element, similar to a barbell.

In addition to the foregoing elements, the grooming rake may have other components built in for safety and/or convenience. While one can lessen the chance that the rake will catch on “stationary” objects, such as a tennis net or post, during use by rounding the corners of the upper surface of the rake body, it may be desirable to add a semi-elliptical, semi-circular or bowed element or a plurality of straight bar elements to the front end of the rake body so as to prevent the grooming rake, while being towed, from catching on structures, objects, trees, and the like or from running over individuals in its path. The semi-elliptical, semi-circular or bowed element will have its ends attached to the opposing ends of the rake body and a midpoint, or near midpoint in the case of an angled tow bar, attached to the an intermediate point along the length of the tow bar.

Alternatively, two straight bar elements may be attached each having one end attached to opposing ends of the rake body and the other end attached to the tow bar at an intermediate point along its length. These elements may be formed of any suitable material including metals, plastics, or reinforced plastics. In use, these elements serve to push the object or individual in the path of the grooming rake out of the path or, if the object is stationary, such as a post or tree, will cause the grooming rake to slide sideways so as to allow the grooming rake to pass the stationary object.

Finally, the grooming rakes may also have a retractable, removable or adjustable set of wheels associated therewith. For example, a pivoting arm having a pivot point at one end and a wheel assembly at the other may be attached at its pivot point to each end of the grooming rake. While the rake is in use, the arm is pivoted so that the wheels no longer engage the surface to be groomed. When grooming is done, the arm is pivoted so that the wheels engage the groomed surface and lift the tines so as to ease the movement of the grooming rake. The extent of the pivot or the length of the arms may be such as to only partially or fully retract the tines from the groomed surface.

Alternatively, the wheels may be mounted on side panels affixed to each end of the rake body, each side panel having a plurality of holes for accepting an axle of other attachment means by which the wheels are affixed to the side panels. The wheels are aligned such that the plane of the wheels is perpendicular to the longitudinal axis of the rake body. By changing the hole in which the axle or wheel attachment means is associated, one can raise and lower the rake body, and hence the tines of the tine assembly, thereby fully extracting the tines for movement of the rake from one location of use to another or regulating the depth to which the tines penetrate the surface being groomed. The use of adjustable wheels is especially suited for rakes that also employ added weights to help dampen or lessen bouncing, as discussed above.

The grooming rakes according to the present application have a number of applications in the sports industry where clay, soil, sand, or other like granular surfaces are employed. In particular, it is especially suited for use in grooming tennis courts, baseball and softball diamonds, bocce courts, running tracks, waste bunkers and sand traps, etc. However, the rake also has applicability beyond the sporting world. For example they may be used to maintain natural and man-made pathways and trails having a loose or compacted (but not bonded) granular surface or make-up.

An especially beneficial feature of the modular tine assemblies is the ease and simplicity with which they may be removed and replaced or repaired. If the tines become so worn that the rake is not performing adequately and there is insufficient tine length to advance the tine elements further, the tine assembly is simply replaced with a new one. If a tine is broken, bent or otherwise damaged, again the tine assembly can be removed and replaced with another while the former is repaired or sent for repair. Alternatively, one can simply remove and repair the tine assembly then and there since the tine assembly is relatively light in weight, as compared to the rake itself, and portable.

Similarly, the modular nature of the tine assemblies allows for a quick and simple interchange capability amongst a variety of different tine assemblies. For example, if a given rake is to be used on a plurality of different surfaces which require different structural and/or performance characteristics and capabilities, e.g., a different spacing between tines, tines of a different width and/or strength, etc., the existing tine assembly is readily removed and replaced with the appropriate tine assembly. When returning to the original surface, the original tine assembly is merely reinserted.

While the foregoing discussion has been directed to the innovative and preferred embodiment wherein the tine assembly is a modular, portable unit, many features described herein are also suitable and lend improvement to existing grooming rake structures, including those existing rakes having one or more key elements of the tine assembly integrated into or forming a part of the rake body. For example, instead of a second rail, the lower edge of the rake body, i.e., the lower edge of the mounting surface, may have a flange extending along its full or nearly full length, which flange is folded n the same direction as will place the flange on the same side of the mounting surface as the first rail and is folded sufficiently so that the plane of the flange is parallel, or essentially so, to the plane of the first rail surface from which the tines extend. The flange has a plurality of spaced holes, which holes coincide with and oppose the holes or recesses in the first rail element so as to accept and pass through the tine elements. For example, such a rake will benefit from the hinge assembly that dampens the bouncing of the rake during use. Such a rake will also benefit by angling the handle or tow bar relative to the longitudinal axis of the rake body. Finally, and perhaps most importantly, while such rakes have employed a movable first rail that is fastened with a tool operated nut and bolt assembly, those assemblies require the full removal of the nut and bolt to advance the first rail, which, especially for large rakes, requires one to turn the rake over in order to have access to that portion of the fastener assembly on the underside of the rake body. Thus, such a rake will clearly benefit from the tine assembly fastener and advance mechanisms described herein wherein only a loosening of the fastener is needed to advance the tines.

Having generally described the grooming rakes and their alternative iterations above, reference is now made to the drawings wherein like reference numerals refer to like parts throughout. For avoidance of confusion, the first rail is also hereinafter referred to as the upper rail, the second rail is also hereinafter referred to as the lower rail and the combination of the first rail and the guard rail are also hereinafter referred to as the upper rail assembly.

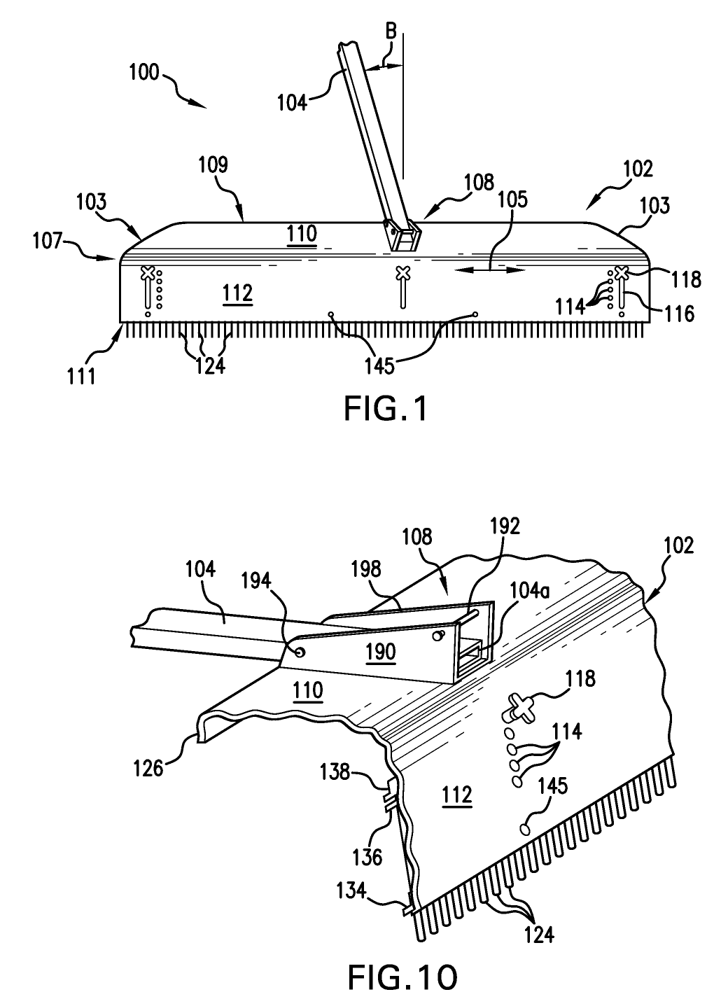

FIG. 1 shows a preferred embodiment of the grooming rake 100 according to the present application. The rake comprises a rake body 102, a tow bar 104 and a tine assembly (not shown) having a plurality of tine elements 124 extending below the lower edge 111 of the rake body. The rake body 102 is beveled along its longitudinal axis 105, dividing the rake body into two surfaces or planes, an upper surface 110 and a lower or mounting surface 112. The forward edge 109 of the upper surface has a flange 126 (as shown in FIGS. 4 and 10) along most if not all of the linear portion of the forward edge extending outward and away from the tow bar at a 90° angle, or thereabouts, relative to the plane of the upper surface 110. This flange provides rigidity and stability to the rake body, especially if it is made of a thin sheet metal. Additionally, as shown, the forward edge 109 of the upper surface 110 ends with a curvature 103 that curves inward to the transition point 107 where the forward edge meets the bevel or fold in the rake body. This curvature 103 establishes a fairly quick transition from the linear portion of the forward edge, parallel to the longitudinal axis of the rake body, to the transition point 107, where the tangent line at the transition point, is at an angle of from 450 to 900 from the longitudinal axis. This curvature helps lessen the chance that the rake body will catch on an object should the operator of the rake bring the rake into contact with one. For example, this curvature will lessen the likelihood that the edge of the rake will catch on a tennis net.

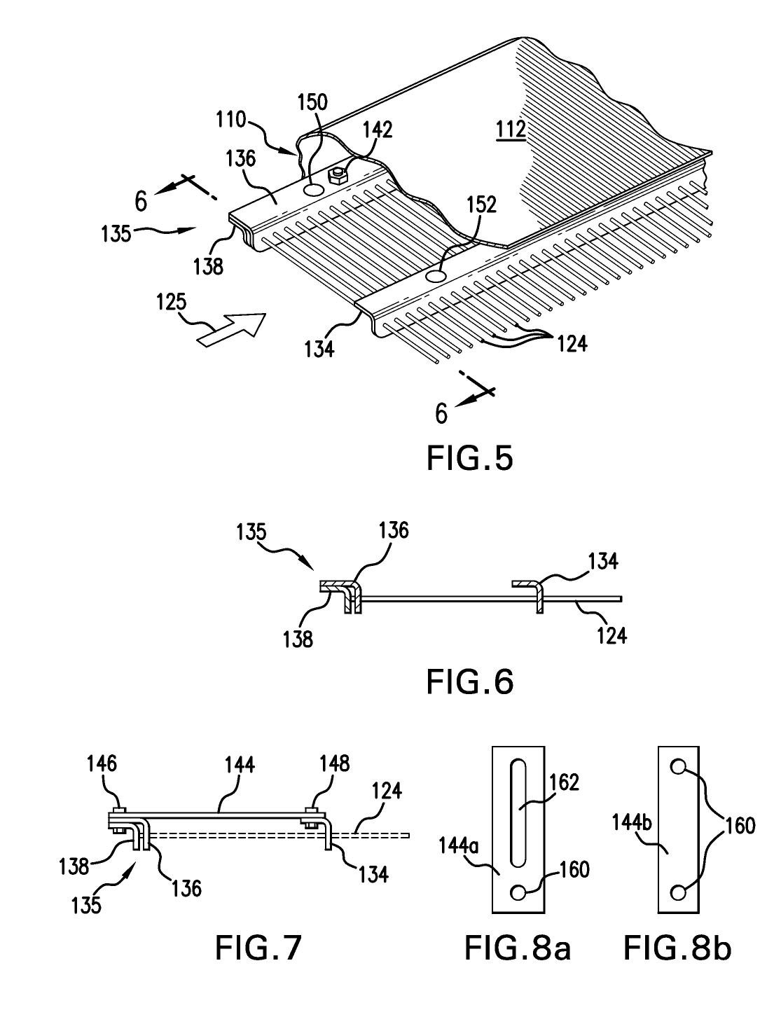

The rake of FIG. 1 also has a tow bar 104 fastened to a hinge assembly 108 that is fastened to the upper surface 110 of the rake body. The tine assembly 125 (as shown in FIG. 5) is mounted and fastened to the mounting surface 112 so that the ends of the tines 124 extending below the lower edge 111 of the mounting surface are visible. As shown in FIG. 1, the tow bar 104 is set at an angle “B” relative to the perpendicular axis to the longitudinal axis of the rake body. This orientation angles the rake body to the forward movement of the grooming rake.

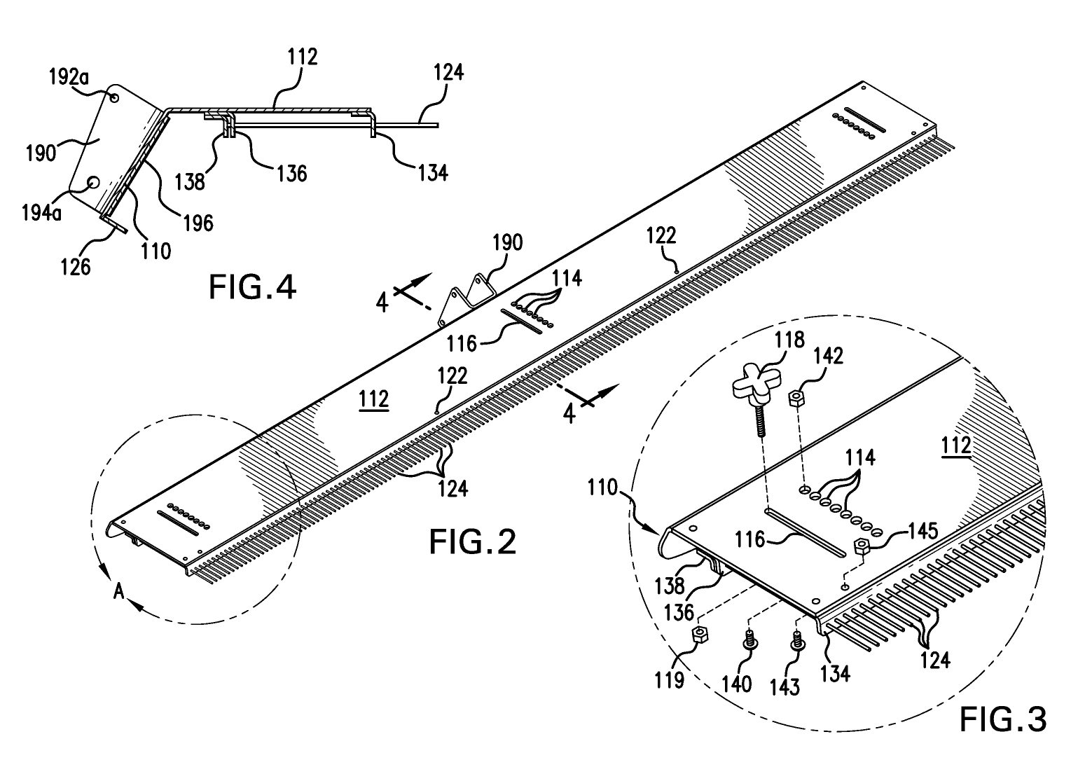

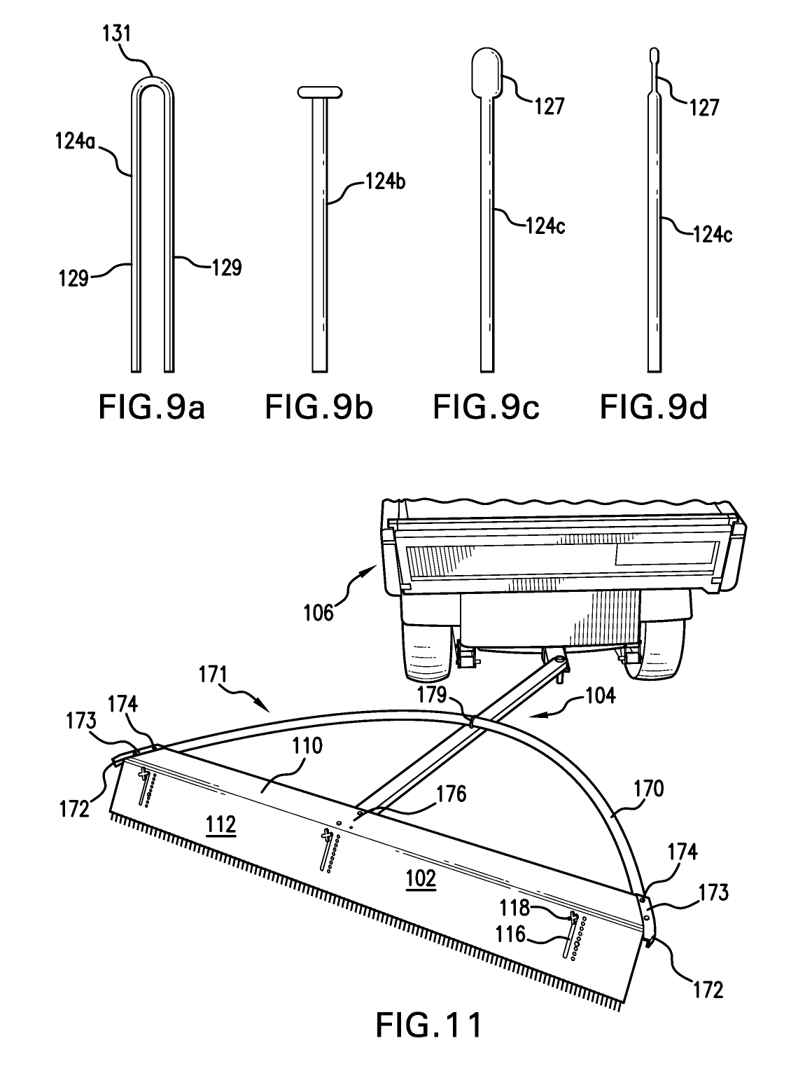

FIGS. 2 thru 4 provide a more detailed view of the rake body with the tine assembly 125, a partial view of which is shown in FIG. 5, in place. As seen in FIGS. 5 and 6, the later being a cross-sectional view of the tine assembly of FIG. 5, the tine assembly 125 is made up of a lower rail element 134 and an upper rail assembly 135 comprising an upper rail element 136 and a guard rail element 138, and a plurality of tine elements 124, the upper end of which is securely engaged by or affixed to the upper rail assembly 135, extending from the upper rail assembly 135 to and through the lower rail element 134. Exemplary shapes of suitable tine element are shown in FIGS. 9a, 9b, 9c and 9d. FIG. 9a shows the preferred tine element which is a “U” shaped tine element 124a where each leg 129 of the “U” tine forms a single tine. FIG. 9b shows a nail head type tine element 124b having a flattened surface perpendicular to the longitudinal axis of the tine element. FIG. 9c depicts a flat ended tine element 124c with FIG. 9d depicting the same rotated 90° about its longitudinal axis. The flattened end of the tine may be formed by stamping and, in use, is folded over so as to catch the upper surface of the upper rail as the tine is inserted into and through the upper rail. The guard rail element 138 overlays the ends of the tine elements 124 and is securely fastened to the upper rail element 136 by fastener 142 (see FIG. 5). As shown in FIG. 6, the heads of the tine elements are sandwiched between the upper rail 136 and the guard rail 138; thereby securing the tines in place. In the case of the “U” shaped tine elements 124a, the medial portion 131of the tine element is secured in place by the guard rail 138. Also, as noted above, the ends of the tine assembly may be affixed to the upper rail element 136, thereby eliminating the need for the guard rail 138. This option is especially suited for the flat ended tine element 124c which may be readily spot welded, fusion bonded, potted, etc. to the upper rail element.

The tine assembly 125 is fastened to the mounting surface 112 using a plurality of fastener elements which pass through a plurality of coordinated bores in the mounting surface and the upper and lower rail elements (134 and 136) of the tine assembly. Specifically, as seen in FIGS. 2, 3 and 5, the mounting surface 112 of the rake body 102 has a plurality of holes 122 along or near its lower edge 111 which match up with holes 152 in the lower rail element 134. A fastener element 143 (a bolt) is inserted though holes 152 and 122 and mated with fastening element 145 (a nut) to secure the lower rail to the rake body. The mounting surface also has a plurality of slots, perpendicular to the longitudinal axis of the rake body, which align with holes 150 in the upper rail assembly 135. A fastener element 118 (a knob bolt) is inserted though the slot 116 and hole 150 and mated with fastening element 119 (a nut) to secure the upper rail assembly 135 to the rake body.

Those structures and elements responsible for the fastening of the upper rail assembly to the rake body also play key roles in the advancing mechanism by which the tines are advanced so as to ensure sufficient length of tine extends beyond the lower edge of the rake body during use: it being understood that the tines wear down in use. Specifically, these elements allow for the advancing of the upper rail assembly so that additional tine length extends through the lower rail and past the lower edge of the rake body. When it is desired to advance the tines, one simply loosens the knob fasteners 118 and advances them in the slots 116 towards the lower edge of the rake body 111 before retightening them: depending upon the size and weight of the rake, it may be easier and more efficient to move the upper rail assembly which will inherently move the fastener knob.

To assist in regulating the extent of the advance, the upper rail assembly has on its upper surface, i.e., that surface facing the mounting surface of the rake body, a stop element. This stop element may be a dedicated stop element, but is preferably the nut element 142 of the fastener 140 securing the guard rail 138 to the upper rail 136. Additionally, the mounting surface 112 also has a plurality of rows of advance holes 114, each row adjacent to and parallel with the slots 116, the rows of advance holes being aligned with the stop element 142 on the tine assembly. Each of the advance holes is preferably equally spaced so that each advance is equidistant. Furthermore the diameter of the advance holes is greater than the diameter or largest cross-dimension of the stop element such that the stop element is able to freely move in and out of the advance holes. Thus, when it is desired to advance the tines, one simply loosens the knob fastener sufficiently enough so that the upper rail assembly is able to back off from the surface of the mounting surface whereby the stop element clears the advance hole. To that end, it is to be noted that the knob bolt has a long bolt or threaded portion to allow for the upper rail assembly to back off without disengaging the nut from the knob bolt.

Once the stop element has cleared the advance hole, the upper rail assembly is the moved forward so that the stop member aligns with the next advance hole. The knob fastener is then tightened so that the stop element penetrates the advance hole and the upper rail assembly is securely fastened to the rake body. Though not a primary purpose, it is also to be noted that the combination of the stop element and the advance holes provides added protection against the unintended advancing or retraction of the tines. Specifically, given the nature of the use of the grooming rakes, the knob fastener may loosen over time, especially if not sufficiently tightened after assembly or the last advance. Consequently, in the absence of the stop element, any loosening of the knob fastener may allow the upper rail assembly to move. The stop element prevents such unintended movement, at least until the knob has backed off sufficiently. However, since the knob is not likely to back off too quickly, checking the knob after each use will guard against this happenstance.

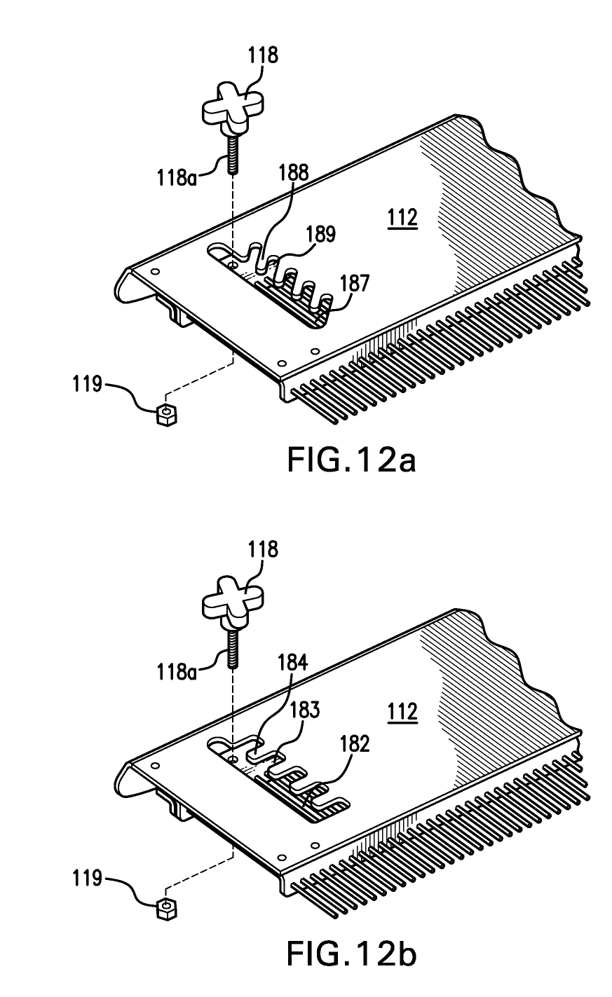

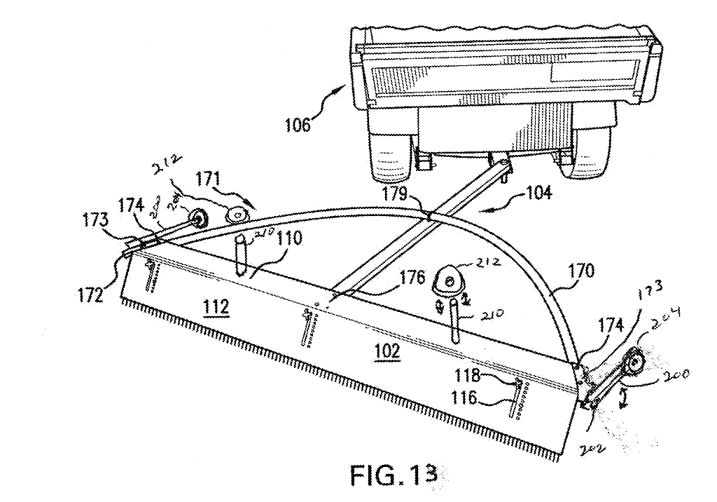

Alternate embodiments of the fastening and advancing mechanism are shown in FIGS. 12a and 12b wherein one of the two sides of the slot is configured in a saw tooth design. Typically, the rake will have two of these fastening and advancing mechanisms, one at or near each end of the rake. As seen in FIG. 12a, teeth 184 and gaps 183 are perpendicular to the longitudinal axis of the slot 182. In use, the knob fastener 118 is loosened from fastener element 119 and advanced in the slot to the next gap and moved transversely so that the stem 118a of the knob fastener is advanced to the end of the gap 183 and the knob fastener then retightened. For added protection against the loosening and inadvertent movement of the knob fastener and, hence, the tine assembly during use, the saw tooth design may be angled relative the longitudinal axis of the slot as shown in FIG. 12b. Here when advancing the tines, the knob fastener 118 is loosened and advanced to the opening of the next tooth gap 189 and then moved transversely while also being retracted so that the stem 118a of the knob fastener is fully retracted into the tooth gap 189 and retightened. Here, even if the knob fastener becomes loose, there is no concern for the retraction of the tines since the weight of the rake body and tine assembly will maintain a downward force on the knob stem 118a and the angle of the gap 189 will prevent any movement.

As mentioned above in the general discussion, in accordance with the most preferred embodiment, the tine assembly is a unitary assembly that can readily be exchanged in and out of the rake body. However, because the lower rail is free moving on the tines, during storage and handling, it is possible for the lower rail to slide off of the tines altogether, which effectively renders the assembly useless and in need of almost, if not complete, reassembly. FIGS. 7, 8a and 8b show a link element, which can be fastened to the tine assembly to maintain the rails in a spaced relationship thereby preventing the lower rail from moving. As shown in FIG. 7, which is a cross-sectional view of the tine assembly through the link element, link element 144 is fastened to lower rail 134 and upper rail assembly 135 by fasteners 148 and 146, respectively. FIG. 8b shows a link element 144b having two holes 160, one at each end of the link element which, when fastened to the tine assembly, will align with corresponding holes on the upper and lower rails. This link element is to be removed before mounting and fastening the tine assembly to the rake body. FIG. 8a, on the other than shows an alternate link element 144a having a hole 160 at one end and a slot 162 at the other and extending to a point intermediate both ends. The length of this slot corresponds to and, when the tine assembly is fastened to the rake body, is aligned with and overlays the slot 116 of the mounting surface. With this construction, the link element need not be removed during assembly as the slot accommodates the movement of the stem of the fastener element during the tine advance operation. Generally, if used, at least two link elements will be employed, one at each end of the tine assembly.

FIG. 10 shows a partial view (only the mid section of the rake body is shown) of yet another embodiment of the grooming rake. This embodiment employs the desired and preferred hinge assembly for attaching the handle or tow bar to the rake body. It also employs a less preferred, though fully functional, fastening and advancing mechanism. Specifically, the rake comprises a rake body 102 having an upper surface 110 and a lower or mounting surface 112 with a flange 126 extending from and essentially perpendicular to the upper surface to add rigidity and stability to the rake body. The tine assembly fastening and advancing mechanism in this embodiment employs parallel rows of holes, preferably equally spaced holes, in the mounting surface, one row at or near each end of the rake body and, optionally, though shown in this figure, another row of holes at or near the midpoint of the rake body along its longitudinal axis. As with the prior embodiment, the lower rail 134 of the tine assembly, is fastened to the lower edge or region of the mounting surface by fastener elements 145. Here, however, the fastener, in this case a knob fastener, 118 must be fully disengaged from its nut or counterpart fastening element and the stem fully retracted from the rake body and then inserted into the next hole and re-engaged with the nut. Again, although functional, with large rakes one must typically turn the rake body over in order to complete the process for advancing the tine assembly. While doable, it is time consuming.

FIG. 10 also provides a more detailed look at the hinge assembly 108. As shown, the hinge assembly comprises a hinge body 190, a fastener 194 for attaching the handle or tow bar 104 to the hinge body, and a stop bolt 192. The hinge body 190 is generally an elongated “U” shaped member whose top edges 198 slope downward from the rear of the body to the front. The use of a slope is purely aesthetic and a mater of material savings, but is not necessary. The hinge body is attached to the upper surface of the rake body by using a plurality of fastener elements, preferably of the nut and bolt type (not shown).

The fastener 194 allows a pivoting of the handle or tow bar, generally owing to use of a bore in the handle or tow bar that is slightly large than the diameter of the fastener. Generally, the fastener 194 is positioned towards the front end of the hinge body 190 and at a height that is essentially at the midpoint from the base of the hinge body to the top edge 198. The dimensions of the hinge body and the tow bar or handle are such that when assembled, the tow bar may pivot about the fastener bolt 190. Generally the extent of this movement is no more than 30°, preferably no more than 20°, from one extreme to the other. This movement is limited by the butt end of the handle or tow bar 104a hitting the stop bolt 192 at one extreme and the base of the hinge body at the other.

Given the strong forces exerted on the upper surface of the rake body at the point of attachment, it is preferred to provide additional reinforcement to the attachment point. As shown in FIG. 4, a reinforcing plate 196 may be placed against the surface of the upper surface 110 of the rake body opposite the hinge body 190. The reinforcing plate is preferably metal and has holes corresponding to and aligned with holes in the base of the hinge body and the upper surface of the rake body (all not shown), so that fasteners may be inserted into the holes in order to fasten and secure the hinge assembly to the rake body. With this configuration, the attachment point of the upper surface 110 is sandwiched between the base of the hinge body 190 and the reinforcing plate 196. This is believed to help distribute the forces exerted by the fasteners on the upper surface over the whole of the contact area of the hinge body and reinforcing plate during use of the grooming rake. Finally, FIG. 11 shows yet another alternative embodiment of a grooming rake 171 being pulled by a motorized vehicle 106. Like the grooming rake of FIG. 1, this grooming rake also uses the tine assembly fastening and advancing system comprising the slots 116 and rows of advance holes 114 together with a knob fastener 118. However, rather than using a hinge assembly for attaching the tow bar 104 to the rake body 102, the tow bar is directly affixed to the upper surface 110 of the rake body by a plurality of fastening elements 176. Additionally, as shown, in this instance, the tow bar 104 is perpendicular to the longitudinal axis of the rake body 102 and is fastened to the underside of the upper surface 110.

The grooming rake of FIG. 11 also incorporates a safety guide 170. The safety guide is a bent hoop element whose ends 172 are attached to opposite ends of the rake body 102 by any suitable fastening means. As shown, each end of the upper surface 110 of the rake body has a flange 173, coplanar with the upper surface of the rake body 102 and extending away from the rake body. This flange 173 has a plurality of holes aligned with holes in the ends of the safety guide through which fasteners 174 fasten the safety guide to the rake body. The safety guide 170 is also fastened or secured to the tow bar 104 at a point intermediate the rake body 102 and the vehicle 106. As shown, the fastener 179 is a “Ω” shaped element with each tab fastened using an appropriate tab fastener, e.g., a screw, to the tow bar. This type fastening means is preferred if the grooming rake has the capability, as discussed above, of adjusting the angle of the tow bar to the longitudinal axis of the rake body. If so, and the inner diameter of the Ω fastener is greater than the diameter of the safety guide 170, then the angle of the tow bar may be adjusted without making any fastener adjustments with respect to the Ω fastener. Otherwise, one merely has to loosen or, depending upon the fastener type, remove the fastener 179 so as to make the appropriate adjustment and placement of the safety guide relative to the new placement of the tow bar.

It should be appreciated and understood that the foregoing description is only illustrative of the invention and that various alternative embodiments and modifications utilizing the concepts of the present invention are possible and can be devised by those skilled in the art without departing from the true scope of the invention. Accordingly, the present invention as embraced and defined by the appended claims is intended to embrace all such alternatives, modifications, variations or equivalents falling within the spirit and scope of the underlying principles.

1. A modular tine assembly consisting essentially of first and second elongated rails positioned in parallel spaced relation to one another, a plurality of tines extending from said first rail to and past the second rail in spaced, parallel relation to one another, means associated with the first rail for fixedly securing the tines to the first rail, means associated with the second rail for securing the tines to the second rail while allowing the tines to reciprocate relative to the second rail, and means for affixing said tine assembly to a rake body, all as a single, assembled unit: said modular tine assembly adapted to being releasably attached to the rake body.

2. (canceled)

3. The time assembly of claim 1 wherein the means for affixing the tine assembly to the rake body comprises a plurality of holes or slots for receiving and allowing fasteners which fasten the tine assembly to the rake body to pass through said holes or slots.

4. The tine assembly of claim 1 wherein the means for affixing the tine assembly to the rake body comprises a plurality of fastener elements releasably or permanently affixed to or integrated into the first and second rails.

5. The tine assembly of claim 1 further consisting essentially of at least one element associated with the tine assembly that temporarily holds the first and second rails in a fixed relationship prior to installation on a rake body.

6. The tine assembly of claim 5 wherein the element is one or more removable bands, ties, straps or strings.

7. The tine assembly of claim 5 wherein the element is a plurality of link elements, each link element being attached at one end to the first rail and at the other end to the second rail.

8. The tine assembly of claim 1 wherein the means associated with the first rail for securing the tines to the first rail comprises a guard rail which cooperates with the first rail to secure the tine elements in place,

9. The tine assembly of claim 8 wherein:
the tines have a head and at least one leg,
the first rail has a plurality of holes through which the leg or legs, but not the head, of the tines pass, and
the first rail and the guard rail each have a planar surface overlaying and parallel to one another whereby when the guard rail is affixed to the first rail, the heads of the tines are sandwiched between the opposing surfaces of the guard rail and the first rail, thereby fixedly securing the tines to the first rail.

10. A rake comprising
a) a rake body having an interior and an exterior surface, an upper and lower edge, and a longitudinal axis parallel to the lower edge, and
b) a modular tine assembly releasably mounted or affixed to one of said interior or exterior surfaces of the rake body comprising i) first and second elongated rails positioned in parallel spaced relation to one another, ii) a plurality of tines extending from said first rail to and past the second rail in spaced, parallel relation to one another, iii) means associated with the first rail for fixedly securing the tines to the first rail, iv) means associated with the second rail for securing the tines to the second rail while allowing the tines to reciprocate relative to the second rail and v) mounting means for releasably mounting or affixing the modular tine assembly to the rake body whereby the second rail is positioned along or proximate to and parallel to the lower edge of the rake body and the first rail is positioned at a point between the second rail and the upper edge of the rake body so that the ends of the tine elements extend beyond the lower ed e of the rake body, and.
c) fastening means which cooperate with the mounting means for mounting or affixing the modular tine assembly to the rake body comprising a plurality of fastener elements which in their fastened state securely fasten the first and second rail elements to the rake body: a plurality of those fastener elements securing the first rail to the rake body having a stem portion, and
d) adjustment means associated with the first rail and the rake body for allowing movement of the first rail relative to the second rail: said adjustment means comprising the stemmed fastener elements associated with the first rail and a plurality of structural features in that portion of the rake body to which the tine assembly is to be a affixed and through which the stem of the stemmed fastener elements passes, said structural features selected from i) a plurality of rows of holes, ii) a plurality of slots, iii) a plurality of a combination of a slot and a row of holes in a side-by-side relationship, or iv) a combination of at least two of the foregoing;
wherein each row of holes has a longitudinal axis extending along each row of holes and each slot has a longitudinal axis extending along the length of each slot: the longitudinal axes of the slots, the rows of holes, or both, whichever is present, being parallel to one another and perpendicular to the longitudinal axis of the rake body; and
wherein the structural features are spaced relative to one another along the longitudinal axis of the rake body,
whereby when the fastener elements for the first rail element are advanced towards the lower edge of the rake body from one hole to the next or from one point to another in the slot, as applicable, and, concurrently, the first rail element is advanced towards the second rail element, the tines extend further away from the lower edge of the rake body and when the fastening means for the first rail element are moved from one hole to the next or from one point to another in slots towards the upper edge of the body and, concurrently, the first rail element is moved away from the second rail element, the tines retract from the extended position.

11. The rake of claim 10 wherein the rake body is folded about its longitudinal axis thereby dividing the rake body into an upper surface and a lower surface, the upper surface having an attachment site for a handle or tow bar and the lower surface having the modular tine assembly releasably affixed or mounted to its interior or exterior surface.

12-14. (canceled)

15. The rake of claim 10 wherein the structural features of the adjustment means comprise a plurality of slots.

16. The rake of claim 15 wherein a side of at least a plurality of the slots has side slots extending transversely to the slot, said side slots receiving the stem of the fastener elements and preventing movement of the fastener stem along the slot should the fastener become loosened.

17. The rake of claim 10 wherein the structural features of the adjustment means comprises a plurality of a combination of a slot and a row of holes in a side-by-side relationship.

18. The rake of claim 17 wherein the stem passes through the slot and one or more stop elements is affixed to or protrudes from a surface of the first rail element at a point corresponding to each row of holes in the rake body such that when the fastener elements for the first rail are tightened, the stop elements engage and penetrate one hole in each row of holes.

19. The rake of claim 10 further comprising a handle or tow bar extending from the upper edge in a direction perpendicular to the longitudinal axis of the rake body.

20. The rake of claim 10 further comprising an adjustable handle or tow bar whereby the angle of the handle or tow bar relative to the path of the rake in use is adjustable to one or more positions.

21. The rake of claim 10 further comprising a handle or tow bar and a hinge assembly by which the handle or tow bar is affixed to the rake body, the hinge allowing the handle or the tow bar to move relative to the rake body in a plane perpendicular to the longitudinal axis of the rake body.

22. The rake of claim 10 further comprising one or more weight increasing elements affixed to the rake body.

23. The rake of claim 10 further comprising a plurality of adjustable or retractable wheels affixed to the rake body.

24. The assembly of claim 1 wherein the means associated with the second rail for securing the tines to the second rail while allowing the tines to reciprocate relative to the second rail comprises holes or recesses in the second rail through which the tines pass.

25. The assembly of claim 1 wherein the means associated with the first rail and by which the tines are fixed to the first rail is selected from a spot weld, a fusion bond, an adhesive bond or a potting compound.

26. The assembly of claim 9 wherein the tines are “U” shaped having parallel legs and, connecting the legs, a bent middle portion, with each leg of the U passing through adjacent holes in the first rail and the head of the time comprising the bent middle portion.

27. (canceled)

28. The rake of claim 10 wherein the adjustment means is operable manually and without the need for tools.

29. A rake comprising
a) a rake body having an interior and an exterior surface, an upper and lower edge, a longitudinal axis parallel to the lower edge, and a flange along its lower edge, and
b) a modular tine assembly releasably mounted or affixed to one of said interior or exterior surfaces of the rake body comprising i) a first rail, ii) a plurality of tines extending from said first rail, iii) means associated with the first rail for fixedly securing the tines to the first rail, and iv) mounting means for releasably mounting or affixing the assembly to the rake body whereby the first rail is positioned at a point removed from, but parallel to and on the same side of the rake body as the flange, and
c) fastening means which cooperate with the mounting means for mounting or affixing the modular tine assembly to the rake body, and
d) adjustment means associated with the first rail and the rake body for allowing movement of the first rail relative to the flange;
wherein said flange has a plurality of spaced holes aligned with and corresponding to each of the tines whereby the tines reciprocatingly pass through the holes and extend past the lower edge of the rake body;
wherein the mounting means, fastening mean, or both comprise a plurality of fastener elements which in their fastened state securely fasten the first rail of the tine assembly to the rake body and wherein a plurality of those fastener elements securing the first rail to the rake body have a stem portion;
wherein the adjustment means comprises said stemmed fastener elements associated with the first rail and a plurality of structural features in that portion of the rake body to which the tine assembly is to be affixed and through which the stem of the stemmed fastener elements passes, said features selected from i) a plurality of slots, iii) plurality of a combination of a slot and a row of holes in a side-by-side relationship, or iii) a combination of at least two of the foregoing or of at least one of the foregoing and a separate row of holes, each row of holes having a longitudinal axis extending along each row of holes and each slot having a longitudinal axis extending along the length of each slot: the longitudinal axes of the slots, the rows of holes, or both, whichever is present, being parallel to one another and perpendicular to the longitudinal axis of the rake body; and
wherein the structural features are spaced relative to one another along the longitudinal axis of the rake body,
whereby, when the fastener elements for the first rail element are advanced towards the lower edge of the rake body from one hole to the next or from one point to another in the slot, as applicable, and, concurrently, the first rail element is advanced towards the lower edge of the rake body, the tines extend further away from the lower edge of the rake body and when the fastening means for the first rail element are moved from one hole to the next or from one point to another in the slots towards the upper edge of the rake body and, concurrently, the first rail element is moved away from the lower edge of the rake body, the tines retract from the extended position.

30. The rake of claim 29 wherein the structural features comprise a plurality of the slots both of whose edges are smooth or at least one edge of which has side slots extending transversely to the slot, said side slots receiving the stem of the fastener elements and preventing movement of fastener stem along the slot should the fastener become loosened.

31. The rake of claim 29 wherein the structure features of the adjustment means comprises a plurality of a combination of a slot and a row of holes in a side-by-side relationship.
